(19) United States
(12) Patent Application Publication
(10) Pub. No.: US 2020/0259948 A1
(43) Pub. Date: Aug. 13, 2020

(54) PERSONALIZED MANAGEMENT OF INCOMING COMMUNICATION

(71) Applicant: INTERNATIONAL BUSINESS MACHINES CORPORATION, ARMONK, NY (US)

(72) Inventors: Susann M. Keohane, Austin, TX (US); Gerald F. McBrearty, Austin, TX (US); Jessica C. Murillo, Round Rock, TX (US); Johnny M. Shieh, Austin, TX (US)

(21) Appl. No.: 16/273,202

(22) Filed: Feb. 12, 2019

(51) Int. Cl. H04M 1/725; G06F 1/16; H04L 29/08; H04W 4/029

(52) U.S. Cl. CPC H04M 1/72577; H04W 4/029; H04L 67/18; G06F 1/163

(57) ABSTRACT

A method, computer system, and a computer program product for managing at least one notification received on a user mobile device is provided. The present invention may include determining a user state associated with a user. The present invention may also include determining at least one personal preference setting associated with the determined user state, wherein the at least one personal preference setting was previously provided. The present invention may then include receiving, on the user mobile device, the at least one notification. The present invention may also include analyzing the received at least one notification. The present invention may further include determining whether the user will accept at least one notification from the user mobile device based on the determined at least one personal preference setting associated with the determined user state.

### BACKGROUND

The present invention relates generally to the field of computing, and more particularly to mobile communication management.

The proliferation of smart phones has led to a deluge of texting and other distractive behavior caused by smart phone use by a driver while operating a vehicle. The cause of the increase in these distractive behaviors may be connected to people (including drivers) becoming overwhelmed with the huge amount of notifications received on their smart phones. Since some instances of distracted drivers have led to dangerous and fatal consequences, many municipalities have prohibited the use of smart phones while operating a vehicle.

### SUMMARY

Embodiments of the present invention disclose a method, computer system, and a computer program product for managing at least one notification received on a user mobile device. The present invention may include determining a user state associated with a user. The present invention may also include determining at least one personal preference setting associated with the determined user state, wherein the at least one personal preference setting was previously provided. The present invention may then include receiving, on the user mobile device, the at least one notification. The present invention may also include analyzing the received at least one notification. The present invention may further include determining whether the user will accept at least one notification from the user mobile device based on the determined at least one personal preference setting associated with the determined user state.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment according to at least one embodiment;

FIG. 2 is an operational flowchart illustrating a process for cognitively managing notifications on a mobile device according to at least one embodiment;

FIG. 3 is a block diagram of internal and external components of computers and servers depicted in FIG. 1 according to at least one embodiment;

FIG. 4 is a block diagram of an illustrative cloud computing environment including the computer system depicted in FIG. 1, in accordance with an embodiment of the present disclosure; and

FIG. 5 is a block diagram of functional layers of the illustrative cloud computing environment of FIG. 4, in accordance with an embodiment of the present disclosure.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language, Python programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method and program product for managing at least one notification received on a user mobile device. As such, the present embodiment has the capacity to improve the technical field of mobile communication management by managing a notification received on a mobile device. More specifically, the personalized notification management program may collect the real-time data associated with a user, and real-time data may then be fed into an analytics engine. Then, the personalized notification management program may receive and analyze a notification (i.e., incoming communication). The personalized notification management program may then determine whether the notification is important, relevant, or urgent. Then, the personalized notification management program may utilize machine learning model to determine whether the user will accept the notification based on the personal preferences of the user, and the state of the user. If the user will accept the notification, then the user is alerted by the personalized notification management program. If, however, the user will decline (or reject) the notification, then the personalized notification management program does not alert the user.

As previously described, the proliferation of smart phones has led to a deluge of texting and other distractive behavior caused by smart phone use by a driver while operating a vehicle. The cause of the increase in these distractive behaviors may be connected to people (including drivers) becoming overwhelmed with the huge amount of notifications received on their smart phones. Since some instances of distracted drivers have led to dangerous and fatal consequences, many municipalities have prohibited the use of smart phones while operating a vehicle.

Therefore, it may be advantageous to, among other things, utilize analytics and heuristics to learn the driving behaviors and customized preferences of a user, to determine whether a user may be alerted to a received notification. Additionally, it may be advantageous to automatically activate (or deactivate) a notification based on the personal preferences of the user.

According to at least one embodiment, the personalized notification management program may provide a more sophisticated level of processing for the notifications a user received on a user mobile device based on the collection of real-time data that is fed into an analytics engine. The personalized notification management program may collect real-time data associated with the user, and feed the collected real-time data into an analytics engine. The personalized notification management program may then determine the personal preferences associated with the user by utilizing analytics and heuristics. Then, the personalized notification management program may receive at least one notification, and based on the personal preferences associated with the user, the personalized notification management program may determine whether the user should be alerted to the received notification.

According to at least one embodiment, the personalized notification management program may define states of the user's activity (i.e., user activity) to determine how to adapt to the needs of the user. For example, the personalized notification management program may determine whether the user is at a desk, at home, driving, traveling (not driving), exercising, standing, or walking. Additionally, the personalized notification management program may determine the health status of the user (e.g., high blood pressure, breathing rate, excessive rate of perspiration, body temperature). The personalized notification management program may utilize wearable devices, a calendar associated with the user, user location and interaction with other devices or software programs (e.g., connected to a car). The present embodiment may include customizable configuration settings for managing notifications for each state.

According to at least one embodiment, the personalized notification management program may set levels of notification and/or auto-reply messages based on the user configuration, such as relaying the time that a notification may be received by the user (e.g., based on the approximate time of arrival to destination, the personalized notification management program may relay that the message will be delivered and received at the time of arrival) and providing the current state of the user (e.g., driving, exercising, mediating). Using existing software programs to estimate the time of arrival to destination and/or when the person will be available to access the mobile device, a sample message, for example, would include, “User A is currently driving. The earliest he will receive your message is in 23 minutes.”

According to at least one embodiment, the personalized notification management program may perform an analysis of the notification to determine the importance or relevancy of the notification, such as who the notification is from (e.g., spouse, child, supervisor, parent) and the urgency of the notification content (e.g., “I need you to call me right now.”). The urgency rating may enable the personalized notification management program to route certain notifications of high importance to a text-to-speech engine and play on the audio of a vehicle while the user is driving.

According to at least one embodiment, the personalized notification management program may feed the analyzed real-time data into other software programs (e.g., global positioning system (GPS) maps). For example, a text, “pick up milk on the way home,” is received from the spouse of the user. The personalized notification management program may identify that the message is from the user's spouse, and utilize the knowledge of the route taken by the user based on the heuristics of daily driving patterns to the home of the user to identify a location to purchase milk. The personalized notification management program may then feed this information to user via audio, and another software program (e.g., mobile pay) to pay for the purchase of milk to expedite the errand.

According to at least one embodiment, if the personalized notification management program determines that the notification is unimportant or irrelevant to the user, then the personalized notification management program may mute all notifications (e.g., no beeps, screen message) to prevent distracting the user while driving.

According to at least one embodiment, the personalized notification management program may provide a sender of the notification with the option to send, delay or “not send” a notification based on the receiver (i.e., user) status. For example, the sender of a text receives a notification that the receiver (i.e., user) is driving and the sender has the option of sending, delaying the sending (i.e., automatically sending the notification at a later time when the user is available), or not sending the notification.

According to at least one embodiment, the personalized notification management program may be utilized by a user who is engaged in an activity other than driving or operating a vehicle (e.g., exercising, running, or playing tennis). As such, the personalized notification management program may be utilized by a user in any state, or during any activity, in which the user prefers to have minimal, if any, disturbances or distractions.

According to at least one embodiment, the user may have to define and configure the various activity states and rate contacts as important, such as child, spouse or boss to activate the user mobile device. The personalized notification management program may predefine states and tailor the user states based on the daily activities of the user.

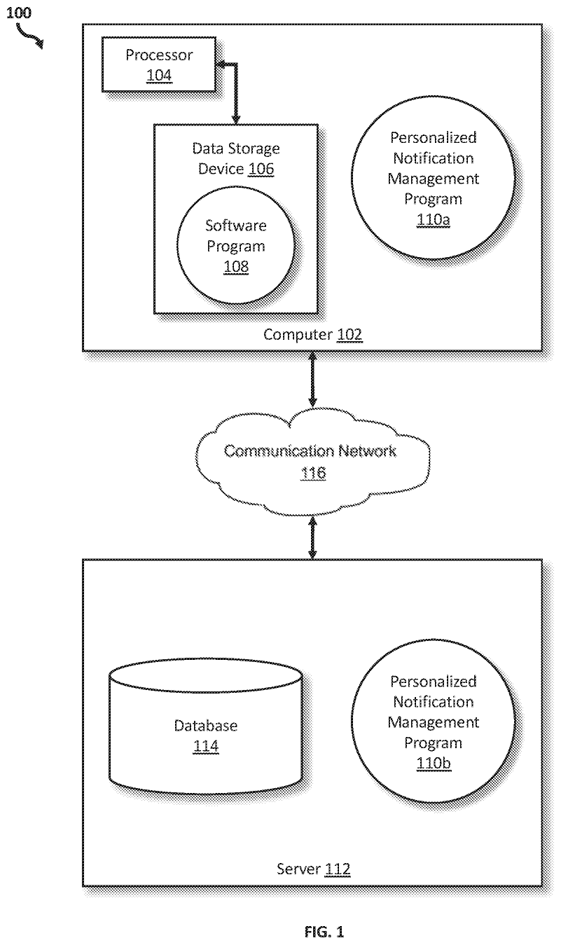

Referring to FIG. 1, an exemplary networked computer environment 100 in accordance with one embodiment is depicted. The networked computer environment 100 may include a computer 102 with a processor 104 and a data storage device 106 that is enabled to run a software program 108 and a personalized notification management program 110a. The networked computer environment 100 may also include a server 112 that is enabled to run a personalized notification management program 110b that may interact with a database 114 and a communication network 116. The networked computer environment 100 may include a plurality of computers 102 and servers 112, only one of which is shown. The communication network 116 may include various types of communication networks, such as a wide area network (WAN), local area network (LAN), a telecommunication network, a wireless network, a public switched network and/or a satellite network. It should be appreciated that FIG. 1 provides only an illustration of one implementation and does not imply any limitations with regard to the environments in which different embodiments may be implemented. Many modifications to the depicted environments may be made based on design and implementation requirements.

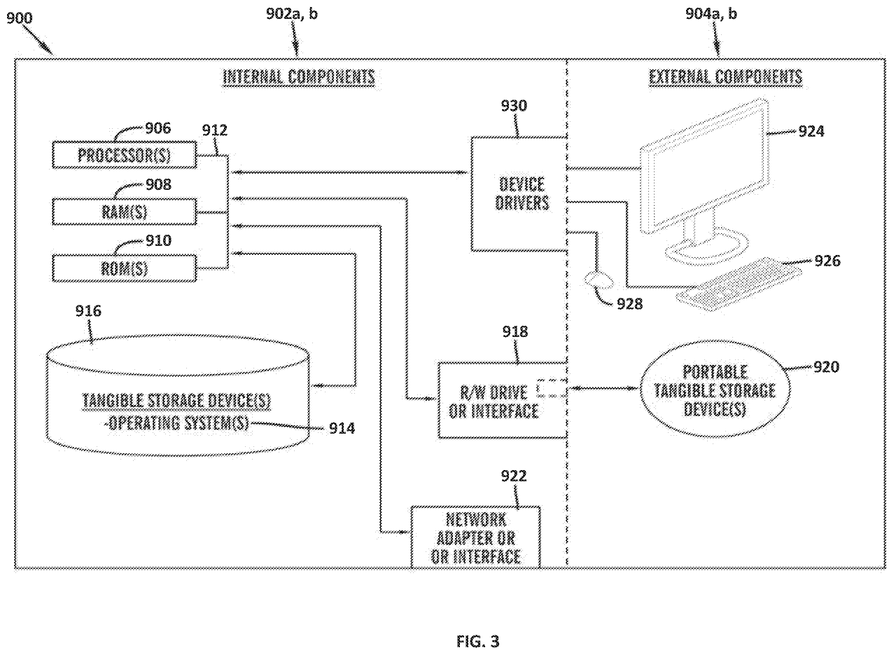

The client computer 102 may communicate with the server computer 112 via the communications network 116. The communications network 116 may include connections, such as wire, wireless communication links, or fiber optic cables. As will be discussed with reference to FIG. 3, server computer 112 may include internal components 902a and external components 904a, respectively, and client computer 102 may include internal components 902b and external components 904b, respectively. Server computer 112 may also operate in a cloud computing service model, such as Software as a Service (SaaS), Analytics as a Service (AaaS), Platform as a Service (PaaS), or Infrastructure as a Service (IaaS). Server 112 may also be located in a cloud computing deployment model, such as a private cloud, community cloud, public cloud, or hybrid cloud. Client computer 102 may be, for example, a mobile device, a telephone, a personal digital assistant, a netbook, a laptop computer, a tablet computer, a desktop computer, or any type of computing devices capable of running a program, accessing a network, and accessing a database 114. According to various implementations of the present embodiment, the personalized notification management program 110a, 110b may interact with a database 114 that may be embedded in various storage devices, such as, but not limited to a computer/mobile device 102, a networked server 112, or a cloud storage service.

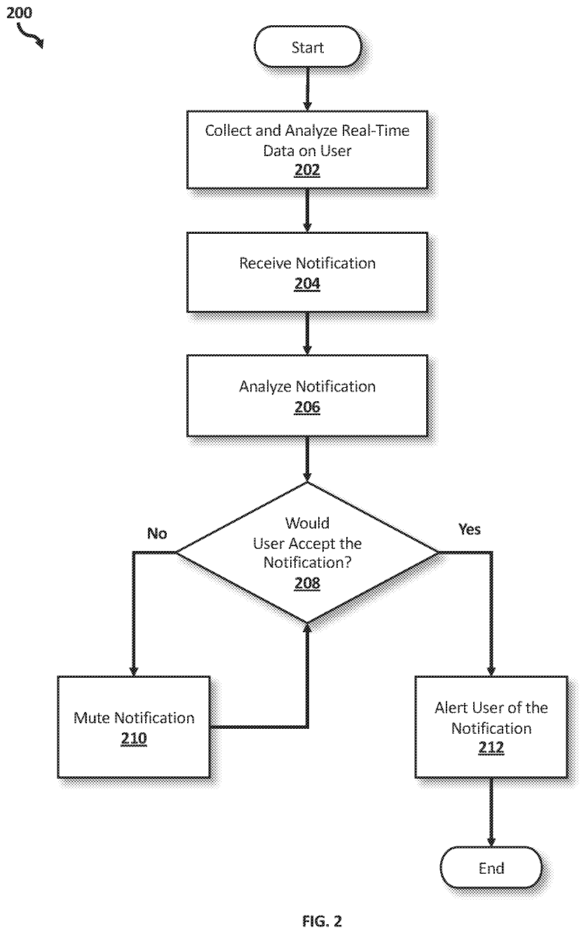

According to the present embodiment, a user using a client computer 102 or a server computer 112 may use the personalized notification management program 110a, 110b (respectively) to manage at least one notification received on a user mobile device . The personalized notification management method is explained in more detail below with respect to FIG. 2.

Referring now to FIG. 2, an operational flowchart illustrating the exemplary cognitive notification management process 200 used by the personalized notification management program 110a and 110b according to at least one embodiment is depicted.

At 202, real-time data associated with the user is collected and analyzed. Utilizing at least one form of wearable device (e.g., wearable health or fitness device), a user mobile device (e.g., smart phone, laptop, tablet), a calendar associated with the user, a global positioning system (GPS) device, or at least one form of other biometric device, via at least one biometric sensor, the personalized notification management program 110a, 110b runs a software program 108 to monitor and collect the real-time data to determine the state (e.g., location, activity, health status) of the user (i.e., user state).

To determine the location of the user, the personalized notification management program 110a, 110b may utilize, for example, a GPS device associated with the user mobile device or wearable device, which utilizes a map-based software to continuously monitor and collect the current location of the user, as well as determine whether the current location of the user is static (i.e., the user is stationary and there are minimal, if any, changes in the location of the user), or in motion (i.e., the user is moving and there is a significant change in the location of the user within a short period of time). To determine the activity of the user, the personalized notification management program 110a, 110b may utilize, for example, a gyroscope and/or an accelerometer associated with the user mobile device or wearable device, which continuously monitors and collects data associated with the user to measure the orientation or motion of the user. If the gyroscope or accelerometer determines that the user's orientation is continuously changing, then the personalized notification management program 110a, 110b may determine that the user is in motion, and based on the heartrate of the user, determined by a biometric sensor associated with the user mobile device or wearable device, the personalized notification management program 110a, 110b may further determine whether the user may be exercising, playing a sport, walking or jogging.

Additionally, the personalized notification management program 110a, 110b may utilize a software program 108 associated with a vehicle of which the user is a driver or passenger to determine the user state by continuously collecting real-time data associated with the location of the vehicle, the time of day, rate of travel (i.e., speed or velocity of the vehicle), and the estimated time of arrival at a particular destination (if applicable).

Alternatively, the user may utilize the personalized notification management program 110a, 110b while exercising, walking, jogging, mediating or a particular user activity. By utilizing augmented reality as another form of wearable device (e.g., augmented reality (AR) glasses or AR gloves), the personalized notification management program 110a, 110b may collect real-time data associated with the user, such as location, heartrate, motion or orientation, and possible destination, to determine the user state.

To determine the user state, the collected real-time data may be fed into an analytics engine, via communication network 116, in which analytics (i.e., analyzes the collected real-time data and assigns values to quantitative information and models, and through use of algorithms and mathematical formulas determines the probable user state) and heuristics (i.e., utilizes past experiences in which the user state was determined, and compares any newly collected real-time data to the previously collected data with a determined user state, and through the process of common sense and comparisons determines the probable user state) are utilized. The resulting data from the analytics engine may be stored in an analytics database (e.g., database 114). The analytics engine may compare the changes in the real-time data collected on the user via the biometric sensors associated with the user mobile device and/or wearable device, and based on the extent or degree of the changes in the real-time data, the analytics engine may determine the user state. For example, if the user's average resting heart rate is 60 beats per minutes (BPM) and currently the user has an escalated heart rate of 90 BPM with minimal change in location based on the GPS device and constant change in motion based on the gyroscope, then the personalized notification management program 110a, 110b may determine that the user is exercising. Additionally, if the user's heartrate has minimal, if any, changes, and the GPS device determines that the user has changed locations, the accelerometer determines that the user is moving at a velocity of 45 miles per hour (which is faster than the average person can move by walking or jogging), and the user mobile device is connected to a vehicle owned by the user, then the analytics engine may determine the user is in a vehicle in which the user is either the driver or a passenger. The personalized notification management program 110a, 110b may also collect data associated with a calendar on the user mobile device (i.e., user calendar). Based on the location of the user and the rate of speed, the analytics engine may determine whether the user is in route to an appointment included in the user calendar. The analytics engine may also utilize the data included on the user calendar (i.e., appointment time and location) to determine whether the user will be on time, late or early, and even estimate the time of arrival to the scheduled appointment based on the user's current location and rate of speed.

In at least one embodiment, the personalized notification management program 110a, 110b may determine the estimated arrival time of the user to a destination based on current traffic patterns. The personalized notification management program 110a, 110b may utilize a known algorithm to determine the shortest path from work to home, and the personalized notification management program 110a, 110b may then, via communication network 116, connect with another software program 108 to determine the current traffic patterns on the shortest path from the user's current location to the destination. Then, based on the user's current rate of travel, average travel time on the shortest path from work to home, and the extent of the current traffic patterns (i.e., how slow or fast other vehicles are driving on the path due to current traffic patterns), the personalized notification management program 110a, 110b may further determine the time that the user should arrive at a destination.

In the present embodiment, prior to collecting real-time data associated with the user, the personalized notification management program 110a, 110b may determine the personal preferences of the user. As such, the user may manually, or by utilizing a virtual assistant or audio-enabled device, configure the personal preference settings (i.e., customizable configuration settings) of the user for managing incoming communications (i.e., notifications). For the personal preference settings, the user may configure whether the user will accept notifications during each state, as well as rank the contacts associated with the user (i.e., user contacts). Depending on the rank of the user contact, the user may elect to mute or silence a notification from that contact during a particular state. For example, the user can elect to mute any notification from the user's co-workers when the user is driving. The personal preferences settings configured by the user and the corresponding resulting data associated with the user state may be stored in the analytics database.

In another embodiment, the user may change, modify, delete or add different configuration settings depending on the time of day, the state or the person sending the notification (i.e., sender). By, for example, clicking on the “Settings” button located on the home screen of the display monitor, the user may be prompted (e.g., via dialog box) to indicate how the user prefers to have the list of personal preference settings presented to the user. The list of personal preference settings, for example, can be sorted and displayed by contact, state or whether the notification should or should not be muted. The user may then click the personal preference settings that the user decides to modify, change or delete. Alternatively, if the user decides to add new personal preference settings, then the user, for example, clicks the “Add” button located on the bottom of the list of personal preference settings. The user will then be prompted, via dialog box, to include the contact, state, and personal preference, such as whether the user will accept notifications from that contact during that particular state. Any change, modification, deletion or addition to the personal preferences settings may be stored in the analytics database.

In some embodiments, any change, modification, deletion or addition to the personal preferences settings in the personalized notification management program 110a, 110b may replace the previous personal preferences setting corresponding to the new personal preferences setting. In another embodiment, any change, modification, deletion or addition to the personal preferences settings in the personalized notification management program 110a, 110b may to be added to the previous personal preferences setting associated with the user to generate a history on the user's personal preferences setting. The user may, at a later date, decide to revert to the previous personal preference settings by manually selecting that previous personal preference from the list of personal preferences settings on the personalized notification management program 110a, 110b.

In another embodiment, the user may include at least one contact that the user will accept any notification from, regardless of the state. The user, for example, decides to accept any notification sent by the user's spouse or children regardless of the user state.

In another embodiment, the user may provide time limits for an existing personal preference setting configured by the user (i.e., temporary personal preferences settings). As such, the user may manually, or by utilizing a virtual assistant or audio-enabled device, configure the temporary personal preference settings of the user for managing notifications. By, for example, clicking on the “Settings” button located on the home screen of the display monitor, the user may be prompted, via dialog box, to indicate how the user prefers to have the list of personal preference settings presented to the user. The list of personal preference settings, for example, can be sorted and displayed by contact, state or whether the notification should or should not be muted. The user may then click the personal preference settings that the user decides to change into a temporary personal preference setting. The user may then be prompted (e.g., via dialog box) to provide the changes. At the bottom of the dialog box is a box for indicating that the personal preference setting is temporary. If the user clicks that box, then the dialog box may expand and the user may provide additional details (e.g., time period) for the personal preference setting. For example, if User A is waiting for a text message from a friend, then User A may include a personal preference setting to notify User A when any text messages are received by User A's friend, even when User A is driving home that evening.

In another embodiment, the user may provide time limits for a new personal preference settings configured by the user (i.e., temporary personal preferences settings). As such, the user may manually, or by utilizing a virtual assistant or audio-enabled device, configure the temporary personal preference settings of the user for managing notifications. By, for example, clicking on the “Settings” button located on the home screen of the display monitor, the user may be prompted (e.g., via dialog box) to indicate how the user prefers to have the list of personal preference settings presented to the user. The list of personal preference settings, for example, can be sorted and displayed by contact, state or whether the notification should or should not be muted. Then the user may click the “Add” button located on the bottom of the list of personal preference settings. The user may then be prompted (e.g., via dialog box) to include the contact, state, and personal preference (e.g., whether the user will accept notifications from that contact or during that particular state). At the bottom of the dialog box is a box for indicating that the personal preference setting is temporary. If the user clicks that box, then the dialog box may expand and the user may provide additional details (e.g., time period) for the personal preference setting. For example, if User A is working on an important project and does not want to be disturbed, then User A may include a personal preference setting in which User A is not accepting any notifications when User A is at User A's desk from 1 pm to 8 pm that day.

The resulting data and the personal preferences settings configured by the user may be utilized for the personalized notification management program 110a, 110b to learn how to process (or manage) notifications sent to the user on the user mobile device. The personalized notification management program 110a, 110b may, for example, determine the particular state of the user and automatically determine the appropriate personal preference for the user.

For example, as User B is operating a vehicle, the personalized notification management program 110a, 110b collects real-time data on User B's current driving status since the vehicle, connected to User B's smart phone, informs User B's smart phone of the User B's current driving status. In addition, based on the data collected on the heuristics of User B's daily schedule and the GPS mapping associated with User B's smart phone, the personalized notification management program 110a, 110b determines that User B is traveling home from work. The personalized notification management program 110a, 110b then utilizes a known algorithm to determine the shortest path from work to home, and the current traffic patterns of that path. Then, based on User B's current rate of travel, average travel time on the shortest path from work to home, and the extent of the current traffic patterns (i.e., how slow or fast other vehicles are driving on the path due to current traffic patterns), the personalized notification management program 110a, 110b further determines that User B should arrive home in 38 minutes.

Next, at 204, a notification is received. Using a software program 108 on the user's mobile device (e.g., user's computer 102), the notification to the user mobile device may be received as input into the user mobile device associated with the personalized notification management program 110a, 110b via a communication network 116. The user mobile device associated with the personalized notification management program 110a, 110b may be continuously listening for such notifications (i.e., incoming communications). The received notification may include short message service (SMS), mobile messaging service (MMS), push notifications, in-app messaging (e.g., emails), and phone calls.

In the present embodiment, the received notification may be transmitted from the user mobile device to the vehicle, via communication network 116, while the user is operating (i.e., driving) the vehicle. The user mobile device may be connected (e.g., paired) to the vehicle, and the user may have to be recognized as the driver.

In another embodiment, the received notification may be transmitted from the user mobile device to another trusted user device (e.g., television and virtual assistant), while the user is performing an activity (e.g., exercising) or during a particular state (e.g., standing in a conference room at work) in which the personal preferences settings configured by the user has indicated that any notifications may be restricted or limited on the personalized notification management program 110a, 110b.

Continuing the previous example, the personalized notification management program 110a, 110b receives the following two text messages for User B:

### First Text Message:

From: User B's cousin
Stating: “how are you doing? I just wanted to find out if you are visiting us this year.”

### Second Text Message:

From: User B's spouse
Stating: “Can you please pick up a half a gallon of whole milk on your way home?”

Then, at 206, the notification is analyzed. The received notification may be entered, as input, into the analytics engine via communication network 116. The analytics engine may then consider several factors, such as the sender of the notification (e.g., spouse, child, parent), the urgency of the context of the notification (e.g., words, phrases, symbols, animated or static images, emojis and punctuations used in the notification), and the location of the sender (i.e., sender location) in relation to the user (e.g., if the user is within a certain range of the sender, or if the user is traveling to the sender). By utilizing analytics and heuristics, the analytics engine may analyze several factors for each notification, and compare the same several factors in one or more previous notifications with a determined level or degree of importance or relevancy to determine the importance or relevancy of the newly received notification.

Additionally, the analytics engine may utilize natural language processing (NLP) techniques, in which the notification may be broken down into shorter, elemental textual pieces (i.e., words or phrases) and non-textual pieces (e.g., emojis, symbols, animated or static images, punctuation marks) to evaluate the relationships between the textual and non-textual pieces and explore how the textual and non-textual pieces work together to create meaning in the notification. As such, the utilization of various NLP techniques (e.g., content categorization, topic discovery and modeling, contextual extraction, sentiment analysis, machine translation, document summarization) may assist with the evaluation of the meaning or context conveyed in the notification. Based on the meaning or context conveyed in the notification, the analytics engine may determine whether the context of the notification is identified or classified as urgent in which an immediate or quick response may be necessary by the user.

In at least one embodiment, the personalized notification management program 110a, 110b may utilize an internal dictionary key to define the elemental textual pieces (or individual words or phrases) in the notification to determine whether the context may be identified or classified as urgent, and whether an immediate or a quick response may be necessary. The internal dictionary key may also include a translation for different languages, slang terms, abbreviations, shorthand writing, symbols, and emojis. If the internal dictionary key determines that an immediate or quick (e.g., less than one hour) response may be necessary based on the individual words or phrases used in the notification, then the personalized notification management program 110a, 110b may classify that the context as urgent.

In the present embodiment, if the internal dictionary key is unable to determine the meaning of an elemental textual or non-textual piece, or the meaning determined by the internal dictionary key fails to match the context conveyed by the rest of the notification, then the internal dictionary key may search the internet, in real-time, for any new or different definitions or meanings that may correspond with the rest of the notification. For example, if the notification states, “that party was bad! I cannot wait for the next party.” The internal dictionary key determines that the term “bad,” which means “of poor quality or standard, and not hoped for, or desired” fails to match the rest of notification, since the sender is expressing excitement or anticipation for the next party. As such, the internal dictionary key searches the internet, and identifies an alternate meaning for “bad” as a colloquial term for “good or something hoped for,” which better matches the context of the rest of the notification. In another example, if the sender includes an animated image to which the internal dictionary key does not have a defined meaning or interpretation for, then the internal dictionary key will, in real-time, search the internet to find a defined meaning or interpretation for the animated image.

In at least one embodiment, the internal dictionary key may periodically search the internet to update the definitions of textual pieces (e.g., words and phrases) and non-textual pieces (e.g., symbols, emojis or animated or static images).

In at least one embodiment, the personalized notification management program 110a, 110b may classify the context of a notification as urgent, if the textual or non-textual pieces indicate or infer that a response may be necessary prior to the estimated conclusion of the user state (e.g., before the user's estimated time of arrival at the destination, or before the user generally finishes exercising).

In some embodiments, the personalized notification management program 110a, 110b may create a hierarchical system in which the several factors (e.g., sender of the notification, the urgency of the context of the notification, location of sender) are ranked to determine the importance or relevance to the user. For example, the user determines that if the sender of the notification is a close family member (e.g., spouse, child, sibling, parent), then the notification is considered important to the user. In another example, the user determines that if the notification is sent by a person who is at, or within one or two miles of the user's intended destination, then the notification is relevant to the user.

In another embodiment, the personalized notification management program 110a, 110b may assign a rating (e.g., high, low, moderate) to each of the factors associated with the notification. If any of the factors is assigned a high rating, then the personalized notification management program 110a, 110b may categorize the notification as important. For example, regardless of the sender or the location of the sender, since the context of the notification indicates a high rating, the personalized notification management program 110a, 110b categorizes the notification as important.

Alternatively, the personalized notification management program 110a, 110b may assign a urgency rating based on the context of the notification. Regardless of the sender or the location of the sender, if the urgency rating is high, then the personalized notification management program 110a, 110b may categorize the notification as urgent and important.

In other embodiments, the personalized notification management program 110a, 110b may assign a percentage (or normalized range in which the total is 1, 10 or 100) of relevance to each of the several factors associated with the notification, and then weigh each factor to determine whether the notification is important or relevant. Therefore, based on the sender of the notification, the sender of the notification factor may be assigned a percentage ranging from 0-35% in which 35% may be a spouse or child. The personalized notification management program 110a, 110b may assign the same percentage range (i.e., 0-35%) for urgency of the context of the notification in which textual or non-textual pieces associated with a near or short period of time (e.g., soon, now, 15 minutes, on the way), or textual or non-textual pieces that are related to the user's destination, may be assigned the higher percentages. The personalized notification management program 110a, 110b may also assign the same percentage range (i.e., 0-35%) for the location of the sender. If the location of the sender is located near the current user location, or the intended destination of the user, then the personalized notification management program 110a, 110b may assign a higher percentage to that notification. If the weighed notification is above a previously determined threshold (e.g., 70%), then the notification may be considered important or relevant.

In the present embodiment, the threshold value may be configured by the user or an administrator. In at least one embodiment, the personalized notification management program 110a, 110b may determine the threshold by utilizing a machine learning (ML) model to identify the distinctions in the user's behavior pattern. If the personalized notification management program 110a, 110b identifies that the user may consider a notification as important, relevant, or urgent, when the factors are calculated above 85%, then the threshold value may move to 85%. If, however, the personalized notification management program 110a, 110b identifies that the user may consider a notification as unimportant, irrelevant, or lacking urgency when the factors are calculated below 40%, then the threshold value may move to 40%.

In at least one embodiment, the personalized notification management program 110a, 110b may determine, by utilizing a machine learning (ML) model to learn patterns in the user's behavior, that the user's decision to accept or decline (or reject) a notification may be based on different or additional factors (e.g., whether the notification is related to a particular task). The personalized notification management program 110a, 110b may utilize historical data associated with past notifications of the user (e.g., context of the notifications, sender location, sender, the user state) and the user's decision (e.g., rejection or acceptance of the notification) to train the ML model. The trained ML model may then produce a proper output that analyzed the historical data to determine the factors that affects whether the user accepted or declined a notification. As such, the personalized notification management program 110a, 110b may modify, change, or adapt the several factors to include the specific factors that are associated with the user's decision to accept or decline a notification. For example, if the personalized notification management program 110a, 110b, through the use of the ML model, analyzes the historical data associated with the user and determines the user is more likely to accept notifications between 12 PM (noon) and 3 PM (regardless of the user state), then the time of day will be included as a factor to determine whether the user will accept or reject a notification. In addition, the percentage applied to each factor is weighted based on the number of factors associated with the user's decision. For example, if the personalized notification management program 110a, 110b utilizes five factors to determine whether the user will accept a notification, then each factor will have a percentage range of 0-20%, in which the highest percentage of 20% is assigned accordingly.

Continuing the previous example, the personalized notification management program 110a, 110b analyzes each of the text messages. The personalized notification management program 110a, 110b identifies the sender and the location of the sender, and utilizes NLP techniques to determine the level of urgency in the context of the text message. The personalized notification management program 110a, 110b then assigns a rating of low, high or moderate to each of the factors associated with the text message. If at least one of the factors is assigned a high rating, then the personalized notification management program 110a, 110b determines that the text message is categorized as important or relevant.

### First Text Message:

Sender: User B's cousin [Low Rating]
Sender Location: more than 300 miles away from User B's current location [Low Rating]
Urgency in Context: the cousin is asking about whether User B will be visiting “next year” [Low Rating]

The first text message has only low ratings. Since the User B's cousin was not previously listed as an important contact and the sender is located more than 300 miles from User B's current location and not at User B's destination, the sender and sender location was given a low rating. In addition, the phrase “next year” does not indicate any urgency in the textual pieces (or context) of the text message, and therefore, the urgency in context was also given a low rating. Therefore, the personalized notification management program 110a, 110b determines that the text message is categorized as unimportant or irrelevant.

### Second Text Message:

Sender: User B's spouse [High Rating]
Sender Location: at home [High Rating]
Urgency in Context: User B's spouse is asking User B to pick up half a gallon of whole milk “on the way home” [High Rating]

The second text message has three high ratings. First, User B previously listed the sender (User B's spouse) as an important contact, and the sender (User B's spouse) is located at User B's destination. Then, the phrase “on the way” indicates a sense of urgency and the fact that the message is related to User B's destination, home, also indicates a sense of urgency. Therefore, the personalized notification management program 110a, 110b determines that the text message is categorized as important or relevant.

Then, at 208, the personalized notification management program 110a, 110b determines if the user would accept the notification. The personalized notification management program 110a, 110b may then analyze the current state of the user with the corresponding personal preferences settings of the user during the current state and the importance of the notification, at the time of receipt, to determine whether the user will accept the notification.

Continuing the previous example, based on the personal preference settings previously configured by User B and the analysis performed by the personalized notification management program 110a, 110b, the personalized notification management program 110a, 110b determines whether the user will accept the notification.

If the personalized notification management program 110a, 110b determines that the user would not accept the notification at 208, then the at least one notification is muted at 210. If the notification is unimportant, irrelevant, or lacks urgency, then the personalized notification management program 110a, 110b may mute (or silence) any verbal alert for receiving the notification until the user state has changed (e.g., the user is no longer driving or exercising has stopped). Additionally, if the personal preference settings indicate that the user will not accept the notification based on the sender, the context or the current user state, then the personalized notification management program 110a, 110b may mute (or silence) any verbal (i.e., audio) alert for receiving the notification until the user state has changed.

Additionally, the personalized notification management program 110a, 110b may continue to monitor the user state until the user state changes. Once a change is detected in the user state, the personalized notification management program 110a, 110b may proceed to 208 to re-evaluate whether the user would accept the notification. The personalized notification management program 110a, 110b may continue to mute the notification until the personalized notification management program 110a, 110b determines that the user will accept the notification.

In another embodiment, the personalized notification management program 110a, 110b may fail to deliver the notification to the user until the user state has changed. As such, the user may fail to receive any audio, motion (e.g., vibration) or visual (e.g., prompt on the screen of the mobile device) alert from the user mobile device until the user state has changed. In doing so, the personalized notification management program 110a, 110b may treat the notification as if the notification was not received by the user until the personalized notification management program 110a, 110b determines that the user state has changed, and the user may accept the notification in new user state.

In another embodiment, the personalized notification management program 110a, 110b may send the sender an auto-reply message to acknowledge that the notification was received by the user mobile device. However, the user may not view the notification for a particular period of time. Additionally, the auto-reply may include the current state of the user and a possible reply time in which the user may respond to the notification. For example, if User A receives a notification while User A is exercising, then the personalized notification management program 110a, 110b may review User A's personal preferences in which User A is not accepting notifications while User A is exercising and instead, approves the personalized notification management program 110a, 110b to send an auto-reply message to the sender. In addition, based on the time for which User A generally exercises, then the personalized notification management program 110a, 110b may provide an estimated time in which User A may receive and respond to the notification. The personalized notification management program 110a, 110b, for example, will send an auto-reply message stating that “User A wishes to not be disturbed right now. However, User A will respond to your message in 49 minutes.”

In the present embodiment, the estimated time may be based on the actual time that the user began exercising and the estimated time of completion based on how long the user generally exercises. In one other embodiment, the estimated time may include a grace period of 10 additional minutes for the user to view and respond to the notification. In at least one other embodiment, the estimated time may include a standard or default time (e.g., one hour) for the user to respond. In another embodiment, the user may elect to not include an estimated time for that particular sender. For example, if User A knows that User A's best friend will expect User A to respond immediately after the 49 minute time period has lapsed, then User A may elect to not include an estimated time in any auto-reply message to User A's best friend. Therefore, User A may respond at User A's discretion without additional pressure to respond to User A's best friend.

In another embodiment, the personalized notification management program 110a, 110b may provide the sender with an option to retract the notification in response to the auto-reply message indicating the user is unavailable at that time. As such, the sender may elect to send the notification at a later time.

In another embodiment, when the notification is received and analyzed, and the personalized notification management program 110a, 110b determines that the user will not accept the notification, then the personalized notification management program 110a, 110b may send a message to the sender notifying the sender that the user is not accepting notifications at this time. The personalized notification management program 110a, 110b may also provide the sender will the option to proceed with sending the notification or not proceed with sending the notification.

Continuing the previous example, since the first text message lacks urgency, is considered irrelevant or unimportant to User B's current location or travel home and the sender was not rated as an important contact in User B's personal preferences settings, the personalized notification management program 110a, 110b determines that User B would not accept the notification while User B is driving. As such, since User B included an auto-reply message to senders, User B's cousin receives the following auto-reply message, “I am driving right now. So, the earliest that I will be able to read your message is in 38 minutes.”

If, however, the personalized notification management program 110a, 110b determines that the user is accepting the notification at 208, then the user is alerted of the at least one notification at 212. If the notification is important, relevant, or categorized as urgent, then the personalized notification management program 110a, 110b may allow any verbal alert for receiving the notification despite the current user state. Additionally, if the personal preference settings indicate that the user will accept the notification based on the sender, the context or the current user state, then the personalized notification management program 110a, 110b may allow any verbal (i.e., audio) alert for receiving the notification despite the current user state.

In the present embodiment, the analytics engine may be integrated into other software programs 108 (e.g., GPS Maps or payment application). As such, the personalized notification management program 110a, 110b may utilize the data associated with the user (e.g., daily driving patterns) to route the user or pay for items along the route of the user. For example, if the user receives a message from a spouse asking the user to purchase several ingredients necessary for dinner during the user's commute to home, then the personalized notification management program 110a, 110b, integrated with a GPS Maps application, determines the user's daily driving patterns and current user location and directs the user to the nearest grocery store where the necessary items are in stock and available for purchase. The personalized notification management program 110a, 110b may even purchase the items, if integrated with a payment application, and notify the grocery store. As such, the items may be available for immediate pick-up at the user's estimated time of arrival at the grocery store.

In the present embodiment, if the user is driving, then the personalized notification management program 110a, 110b may route these notifications to a text-to-speech engine and play the notification on the audio associated with the vehicle operated by the user. In another embodiment, if the user is exercising, then the personalized notification management program 110a, 110b may route these notifications to a text-to-speech engine and play the notification on the user mobile device. If the user is exercising indoors, the personalized notification management program 110a, 110b may route these notifications to a text-to-speech engine, or text-to-text engine and play or display the notification on a television screen or user's computer 102 that is connected to the user mobile device.

Continuing the previous example, since the second text message is categorized as urgent, considered relevant or important to User B's current location or travel home and the sender was rated as an important contact on User B's personal preferences settings, the personalized notification management program 110a, 110b determines that User B would accept the notification while User B is driving. The personalized notification management program 110a, 110b is integrated with a GPS Maps application. Therefore, the personalized notification management program 110a, 110b determines that there is a grocery store, with at least one half a gallon of whole milk available for purchase, approximately 2 miles northeast along User B's current route. As such, the personalized notification management program 110a, 110b, which is connected to a text-to-speech engine on the vehicle's audio system, delivers the notification from User B's spouse to User B, via User B's vehicle audio system. The personalized notification management program 110a, 110b also informs User B of the grocery store located approximately 2 miles away. Since User B's smart phone is connected to a payment application, the personalized notification management program 110a, 110b, via the vehicle's audio system, asks User B whether User B wants to purchase a half a gallon of whole milk from the grocery store, and have the milk available for pick up at the grocery store when User B arrives. As such, User B may verbally respond to the vehicle audio system accordingly.

In the another embodiment, the personalized notification management program 110a, 110b may utilize an algorithm to manage notifications on behalf of the user. The personalized notification management program 110a, 110b may utilize the historical data associated with past notifications of the user (e.g., context of the notifications, sender location, sender, the user state) and the user's decision (e.g., rejection or acceptance of the notification) to train a machine learning (ML) model (i.e., a process in which the user feeds an enormous amount of data into a computer algorithm and the computer analyzes and makes data-driven recommendations and decisions based on only the input data. In addition, any changes identified are incorporated to improve future recommendation and decision-making) to generate recommendations or decisions for future notifications to the user. Based on the recommendations or decisions generated from the ML model, the personalized notification management program 110a, 110b may then adapt to the user's needs and current state of being. Based on the trained ML model, the personalized notification management program 110a, 110b may determine whether a received notification, from an unknown or new sender, may be accepted by the user during the user state. For example, User B receives a notification from a unknown caller stating, “Your child's elementary school is closing early today due to severe weather alerts. Please make arrangements to have your child picked up before 11:30 AM.” Based on the urgency of the message, the personalized notification management program 110a, 110b determines that the message is important and the unknown caller may be someone associated with the elementary school attended by User B's child. As such, the message is delivered to User B.

The functionality of a computer may be improved by the personalized notification management program 110a, 110b because the personalized notification management program 110a, 110b may establish a hierarchical system of importance based on the sender (i.e., the person calling or communicating with the user), the time of the notification, the current driving conditions or current activity of the user, destination of the user (i.e., where the user is driving) and other suitable information associated with the notification, and may tailor an appropriate informative reply message based on learned driving habits associated with the user. The personalized notification management program 110a, 110b may further learn the behavior of the user, and adapt to the user preferences. In addition, the sender may send a notification and the user may possess the ability to receive the notification in various multi-modalities based on user preference settings (e.g., audible alert, speech to text via car's speaker system, and other suitable settings).

The functionality of the computer may be further improved by the personalized notification management program 110a, 110b because the personalized notification management program 110a, 110b may be more user friendly with an improved user interface. In addition, with the personalized notification management program 110a, 110b, less interaction of the user may be necessary. The personalized notification management program 110a, 110b may not have the user manually accept or reject a notification, instead the personalized notification management program 110a, 110b automatically performs that function on behalf of the user based on the user preference settings and the user state, which may eliminate distractive behaviors such as a user using a smart phone while operating a vehicle. Furthermore, after continuous utilization of the personalized notification management program 110a, 110b by the user, the personalized notification management program 110a, 110b may better adapt and understand the user, and may be able to make more accurate recommendations or decisions on the notifications received based on the user preferences and user state.

It may be appreciated that FIG. 2 provides only an illustration of one embodiment and does not imply any limitations with regard to how different embodiments may be implemented. Many modifications to the depicted embodiment(s) may be made based on design and implementation requirements.

FIG. 3 is a block diagram 900 of internal and external components of computers depicted in FIG. 1 in accordance with an illustrative embodiment of the present invention. It should be appreciated that FIG. 3 provides only an illustration of one implementation and does not imply any limitations with regard to the environments in which different embodiments may be implemented. Many modifications to the depicted environments may be made based on design and implementation requirements.

Data processing system 902, 904 is representative of any electronic device capable of executing machine-readable program instructions. Data processing system 902, 904 may be representative of a smart phone, a computer system, PDA, or other electronic devices. Examples of computing systems, environments, and/or configurations that may represented by data processing system 902, 904 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

User client computer 102 and network server 112 may include respective sets of internal components 902a, b and external components 904a, b illustrated in FIG. 3. Each of the sets of internal components 902a, b includes one or more processors 906, one or more computer-readable RAMs 908 and one or more computer-readable ROMs 910 on one or more buses 912, and one or more operating systems 914 and one or more computer-readable tangible storage devices 916. The one or more operating systems 914, the software program 108 and the personalized notification management program 110a in client computer 102, and the personalized notification management program 110b in network server 112, may be stored on one or more computer-readable tangible storage devices 916 for execution by one or more processors 906 via one or more RAMs 908 (which typically include cache memory). In the embodiment illustrated in FIG. 3, each of the computer-readable tangible storage devices 916 is a magnetic disk storage device of an internal hard drive. Alternatively, each of the computer-readable tangible storage devices 916 is a semiconductor storage device such as ROM 910, EPROM, flash memory or any other computer-readable tangible storage device that can store a computer program and digital information.

Each set of internal components 902a, b also includes a R/W drive or interface 918 to read from and write to one or more portable computer-readable tangible storage devices 920 such as a CD-ROM, DVD, memory stick, magnetic tape, magnetic disk, optical disk or semiconductor storage device. A software program, such as the software program 108 and the personalized notification management program 110a and 110b can be stored on one or more of the respective portable computer-readable tangible storage devices 920, read via the respective R/W drive or interface 918 and loaded into the respective hard drive 916.

Each set of internal components 902a, b may also include network adapters (or switch port cards) or interfaces 922 such as a TCP/IP adapter cards, wireless Wi-Fi interface cards, or 3G or 4G wireless interface cards or other wired or wireless communication links. The software program 108 and the personalized notification management program 110a in client computer 102 and the personalized notification management program 110b in network server computer 112 can be downloaded from an external computer (e.g., server) via a network (for example, the Internet, a local area network or other, wide area network) and respective network adapters or interfaces 922. From the network adapters (or switch port adaptors) or interfaces 922, the software program 108 and the personalized notification management program 110a in client computer 102 and the personalized notification management program 110b in network server computer 112 are loaded into the respective hard drive 916. The network may comprise copper wires, optical fibers, wireless transmission, routers, firewalls, switches, gateway computers and/or edge servers.

Each of the sets of external components 904a, b can include a computer display monitor 924, a keyboard 926, and a computer mouse 928. External components 904a, b can also include touch screens, virtual keyboards, touch pads, pointing devices, and other human interface devices. Each of the sets of internal components 902a, b also includes device drivers 930 to interface to computer display monitor 924, keyboard 926 and computer mouse 928. The device drivers 930, R/W drive or interface 918 and network adapter or interface 922 comprise hardware and software (stored in storage device 916 and/or ROM 910).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Analytics as a Service (AaaS): the capability provided to the consumer is to use web-based or cloud-based networks (i.e., infrastructure) to access an analytics platform. Analytics platforms may include access to analytics software resources or may include access to relevant databases, corpora, servers, operating systems or storage. The consumer does not manage or control the underlying web-based or cloud-based infrastructure including databases, corpora, servers, operating systems or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

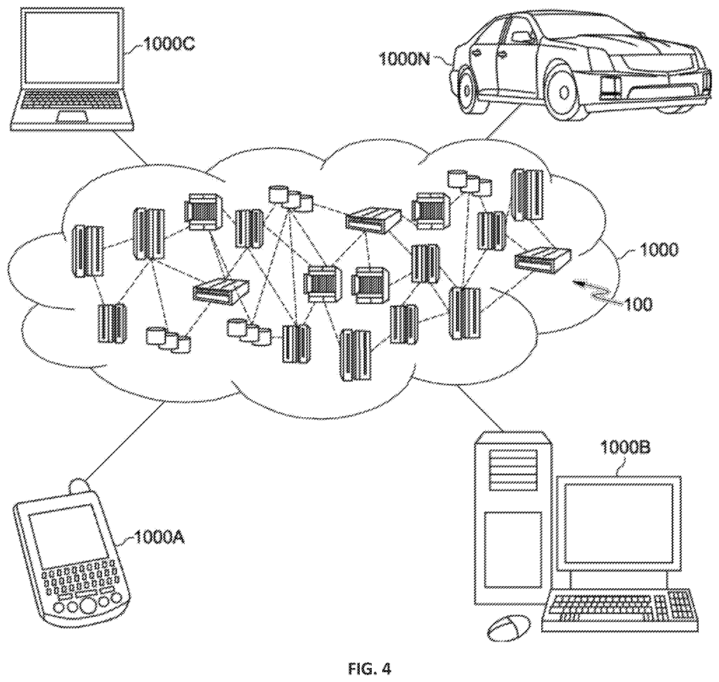

Referring now to FIG. 4, illustrative cloud computing environment 1000 is depicted. As shown, cloud computing environment 1000 comprises one or more cloud computing nodes 100 with which local computing devices used by cloud consumers, such as, for example, personal digital assistant (PDA) or cellular telephone 1000A, desktop computer 1000B, laptop computer 1000C, and/or automobile computer system 1000N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 1000 to offer infrastructure, platforms and/or software as services for which a cloud consumer does not need to maintain resources on a local computing device. It is understood that the types of computing devices 1000A-N shown in FIG. 4 are intended to be illustrative only and that computing nodes 100 and cloud computing environment 1000 can communicate with any type of computerized device over any type of network and/or network addressable connection (e.g., using a web browser).

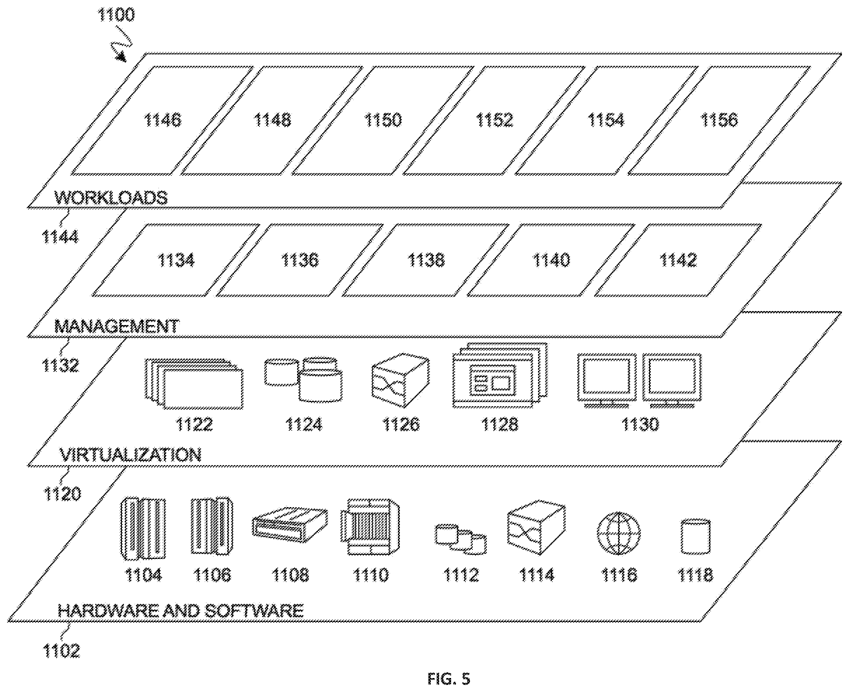

Referring now to FIG. 5, a set of functional abstraction layers 1100 provided by cloud computing environment 1000 is shown. It should be understood in advance that the components, layers, and functions shown in FIG. 5 are intended to be illustrative only and embodiments of the invention are not limited thereto. As depicted, the following layers and corresponding functions are provided:

Hardware and software layer 1102 includes hardware and software components. Examples of hardware components include: mainframes 1104; RISC (Reduced Instruction Set Computer) architecture based servers 1106; servers 1108; blade servers 1110; storage devices 1112; and networks and networking components 1114. In some embodiments, software components include network application server software 1116 and database software 1118.

Virtualization layer 1120 provides an abstraction layer from which the following examples of virtual entities may be provided: virtual servers 1122; virtual storage 1124; virtual networks 1126, including virtual private networks; virtual applications and operating systems 1128; and virtual clients 1130.

In one example, management layer 1132 may provide the functions described below. Resource provisioning 1134 provides dynamic procurement of computing resources and other resources that are utilized to perform tasks within the cloud computing environment. Metering and Pricing 1136 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 1138 provides access to the cloud computing environment for consumers and system administrators. Service level management 1140 provides cloud computing resource allocation and management such that required service levels are met. Service Level Agreement (SLA) planning and fulfillment 1142 provide pre-arrangement for, and procurement of, cloud computing resources for which a future requirement is anticipated in accordance with an SLA.

Workloads layer 1144 provides examples of functionality for which the cloud computing environment may be utilized. Examples of workloads and functions which may be provided from this layer include: mapping and navigation 1146; software development and lifecycle management 1148; virtual classroom education delivery 1150; data analytics processing 1152; transaction processing 1154; and personalized notification management program 1156. A personalized notification management program 110a, 110b provides a way to manage a plurality of notifications received on a user mobile device.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method for managing at least one notification received on a user mobile device, the method comprising:
determining a user state associated with a user;
determining at least one personal preference setting associated with the determined user state, wherein the at least one personal preference setting was previously provided;
receiving, on the user mobile device, the at least one notification;
analyzing the received at least one notification;
determining whether the user will accept the analyzed at least one notification from the user mobile device based on the determined at least one personal preference setting associated with the determined user state,
wherein a machine learning model is trained to learn one or more behavior patterns associated with the user based on a set of historical data associated with past notifications of the user and a user decision on the past notifications,
wherein one or more recommendations are generated from the machine learning model; and
automatically presenting, to a sender of the at least one notification, at least one reply message to the analyzed at least one notification based on the one or more recommendations, the at least one reply message including an indication based on the user state.

2. The method of claim 1, further comprising:
in response to determining the user would reject the analyzed at least one notification, muting the analyzed at least one notification.

3. The method of claim 2, further comprising:
in response to determining the user would accept the analyzed at least one notification, alerting the user of the analyzed at least one notification.

4. The method of claim 1, wherein determining the user state associated with the user, further comprises:
collecting a plurality of real-time data associated with the user by utilizing at least one biometric sensor or at least one wearable device; and
analyzing the collected plurality of real-time data associated with the user.

5. The method of claim 1, wherein analyzing the received at least one notification, further comprises:
identifying a sender of the received at least one notification; and
determining a sender location in relation to a current user location.

6. The method of claim 5, further comprising:
determining whether a context of the received at least one notification is urgent;
in response to determining that the context of the received at least one notification is urgent, alerting the user of the received at least one notification.

7. The method of claim 6, further comprising:
in response to determining that the context of the received at least one notification lacks urgency, comparing the previously provided personal preferences settings to determine whether the sender is rated as an important contact; and
in response to determining that the sender is an important contact to the user, alerting the user of the received at least one notification.

8. The method of claim 7, further comprising:
in response to determining that the sender is not an important contact to the user, muting the received at least one notification.

9. A computer system for managing at least one notification received on a user mobile device, comprising:
one or more processors, one or more computer-readable memories, one or more computer-readable tangible storage media, and program instructions stored on at least one of the one or more computer-readable tangible storage media for execution by at least one of the one or more processors via at least one of the one or more memories, wherein the computer system is capable of performing a method comprising:
determining a user state associated with a user;
determining at least one personal preference setting associated with the determined user state, wherein the at least one personal preference setting was previously provided;
receiving, on the user mobile device, the at least one notification;
analyzing the received at least one notification;
determining whether the user will accept the analyzed at least one notification from the user mobile device based on the determined at least one personal preference setting associated with the determined user state,
wherein a machine learning model is trained to learn one or more behavior patterns associated with the user based on a set of historical data associated with past notifications of the user and a user decision on the past notifications,
wherein one or more recommendations are generated from the machine learning model; and
automatically presenting, to a sender of the at least one notification, at least one reply message to the analyzed at least one notification based on the one or more recommendations, the at least one reply message including an indication based on the user state.

10. The computer system of claim 9, further comprising:
in response to determining the user would reject the analyzed at least one notification, muting the analyzed at least one notification.

11. The computer system of claim 10, further comprising:
in response to determining the user would accept the analyzed at least one notification, alerting the user of the analyzed at least one notification.

12. The computer system of claim 9, wherein determining the user state associated with the user, further comprises:
collecting a plurality of real-time data associated with the user by utilizing at least one biometric sensor or at least one wearable device; and
analyzing the collected plurality of real-time data associated with the user.

13. The computer system of claim 9, wherein analyzing the received at least one notification, further comprises:
identifying a sender of the received at least one notification; and
determining a sender location in relation to a current user location.

14. The computer system of claim 13, further comprising:
determining whether a context of the received at least one notification is urgent;
in response to determining that the context of the received at least one notification is urgent, alerting the user of the received at least one notification.

15. The computer system of claim 14, further comprising:
in response to determining that the context of the received at least one notification lacks urgency, comparing the previously provided personal preferences settings to determine whether the sender is rated as an important contact; and
in response to determining that the sender is an important contact to the user, alerting the user of the received at least one notification.

16. The computer system of claim 15, further comprising:
in response to determining that the sender is not an important contact to the user, muting the received at least one notification.

17. A computer program product for managing at least one notification received on a user mobile device, comprising:
one or more computer-readable storage tangible media and program instructions stored on at least one of the one or more non-transitory computer readable medium the program instructions executable by a processor to cause the processor to perform a method comprising:
determining a user state associated with a user;
determining at least one personal preference setting associated with the determined user state, wherein the at least one personal preference setting was previously provided;
receiving, on the user mobile device, the at least one notification;
analyzing the received at least one notification;
determining whether the user will accept the analyzed at least one notification from the user mobile device based on the determined at least one personal preference setting associated with the determined user state,
wherein a machine learning model is trained to learn one or more behavior patterns associated with the user based on a set of historical data associated with past notifications of the user and a user decision on the past notifications,
wherein one or more recommendations are generated from the machine learning model; and
automatically presenting, to a sender of the at least one notification, at least one reply message to the analyzed at least one notification based on the one or more recommendations, the at least one reply message including an indication based on the user state.

18. The computer program product of claim 17, further comprising:
in response to determining the user would reject the analyzed at least one notification, muting the analyzed at least one notification.

19. The computer program product of claim 18, further comprising:
in response to determining the user would accept the analyzed at least one notification, alerting the user of the analyzed at least one notification.

20. The computer program product of claim 17, wherein determining the user state associated with the user, further comprises:
collecting a plurality of real-time data associated with the user by utilizing at least one biometric sensor or at least one wearable device; and
analyzing the collected plurality of real-time data associated with the user.
